(19) United States
(12) Patent Application Publication
(10) Pub. No.: US 2005/0058360 A1
(43) Pub. Date: Mar. 17, 2005

(54) Imaging system and method for displaying and/or recording undistorted wide-angle image data

(76) Inventors: Thomas Berkey, Tavemier, FL (US); Daniel P. Fuoco, Boca Raton, FL (US); Lawrence R. Mills, Coral Springs, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/803,004

(22) Filed: Mar. 17, 2004

Related U.S. Application Data
(60) Provisional application No. 60/502,700, filed on Sep. 12, 2003.

(51) Int. Cl. G06K 9/36; G06K 9/46

(52) U.S. Cl. 382/254; 382/276

(57) ABSTRACT

An imaging system produces undistorted image data from buffered wide-angle image data without the need for a separate output buffer. Wide-angle image data is transformed, on a pixel-by-pixel basis, as the data for a pixel is required for encoding, to produce output signals in real-time. Predetermined values for functions used in the transformation process are obtained from one or more look-up tables to facilitate transformation.

### CROSS REFERENCE TO RELATED APPLICATIONS

The present application claims the benefit of the filing date of U.S. Provisional Application Ser. No. 60/502,700, filed Sep. 12, 2003, entitled “Imaging System and Method for Displaying and/or Recording Undistorted Wide-Angle Image Data,” the entire teachings of which are incorporated herein by reference. This application is related to co-pending U.S. application Ser. No. ______, filed Mar. 17, 2004, entitled “Video User Interface System and Method.”

### BACKGROUND OF THE INVENTION

1. Field of the Invention

This invention generally relates to imaging systems, and more particularly, to a system and method for generating undistorted image data, such as video signals suitable for display and/or recording by conventional equipment, from wide-angle lens image data.

2. Background Description

Conventional video surveillance systems allow users to view portions of monitored areas by either physically aiming a video camera at a desired portion or by generating a perspective corrected view of the desired portion from a wide-angle (e.g., fisheye) image of the monitored area. Signals from the video camera are typically decoded into digital video data. The data is then buffered for processing. In the case of wide-angle image data, processing may entail performing complex mathematical transformations to remove wide-angle distortion. As the data is transformed, it is typically sent to an output buffer before it is encoded for output to a display or recorder. Such conventional systems have several shortcomings.

One drawback of such conventional systems is that they tend to rely upon complex microprocessors, such as Reduced Instruction Set Computer (RISC) chips or Complex Instruction Set Computer (CISC) microprocessors, that utilize task scheduling and other functionality to achieve rapid processing of complex instructions for real-time performance. These tend to be expensive and complicated chips because of the many different tasks they are capable of performing.

Another drawback of conventional systems is that they tend to rely on a processor for performing all computations. Transformation algorithms typically require performance of many floating point, trigonometric and division operations, as well as other complex mathematical functions that consume appreciable processor resources and time.

Yet another drawback of conventional systems is that they typically require an output buffer. Such systems transform input image data from an input buffer into output image data in an output buffer. Transformed data stored in the output buffer is then scan converted by an encoder to produce output signals suitable for a display device or a recorder. Disadvantageously, the output buffer increases overall cost and signal latency.

While the invention overcomes one or more of the problems in conventional video surveillance systems as set forth above, it should be apparent that the invention may have applicability to a wide array of imaging systems and methods, regardless of the particular format of the image data.

### SUMMARY OF THE INVENTION

The invention avoids the drawbacks and disadvantages of the prior art by providing an imaging system that produces undistorted image data from buffered wide-angle image data while eliminating the need for a separate output buffer. According to one aspect of the invention, the imaging system includes an input buffer configured to store wide-angle image data. The input buffer is operably coupled to an image data processor configured to transform wide-angle image data stored in the input buffer into corrected, such as undistorted, image data in a format suitable for at least display and/or recording of corrected images. An encoder operably coupled to the image data processor is configured to receive and encode the corrected image data. The transformation and encoding are performed without using a separate output image buffer. Thus, the corrected image data is not stored in a buffer from the time of transformation by the image data processor until the time the corrected image data is received by the encoder.

In another aspect of the invention, a method for displaying and/or recording corrected image data from wide-angle image data, without the use of an output image buffer, is provided. The method entails buffering wide-angle image data. Next, the buffered wide-angle image data is transformed into corrected image data. The corrected image data is then encoded into one or more output signals. Again, the corrected image data is not buffered from the time of transformation until the time the corrected image data is encoded. The output signals from the encoder may then be displayed and/or recorded.

In yet another aspect of the invention, another system for producing corrected image data from wide-angle image data may include a first means for storing wide-angle image data. The system also includes a means for transforming wide-angle image data stored in the storing means into corrected image data. The transformation means is operably coupled to the storing means. Additionally, the system includes a means for encoding the corrected image data into a format suitable for at least one of display and recording of the corrected images. The encoding means is operably coupled to the image data processor means. The corrected image data is not stored in a buffer from the time of transformation by the transformation means until the time the corrected image data is received by the encoding means.

Optionally, the system may generate a graphical user interface that provides a plurality of substantially undistorted views from the wide-angle image data, including, for example, a panoramic view that provides a substantially undistorted view based on the wide-angle image data, a virtual view corresponding to a portion of the panoramic view based upon wide-angle data or other image data, and a display reference window overlaid in a panoramic view to identify the portion of a panoramic view represented by the virtual view. As another option, the system may include a dome camera system configured to provide image data for a virtual view according to commands. The dome camera image data may exhibit higher resolution than the wide-angle data.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate preferred embodiments of the invention and together with the detail description serve to explain the principles of the invention. In the drawings:

FIG. 1 is a block diagram that conceptually shows an exemplary imaging system for producing undistorted image data from buffered wide-angle image data without an output image buffer in accordance with the principles of the invention;

FIG. 2 is an enlarged block diagram that conceptually illustrates the graphical user interface shown in FIG. 1;

FIG. 3 conceptually shows θ (i.e., the pan rotation angle around the Z-axis) and φ (the tilt rotation angle around the X-axis) for a transformation in accordance with the principles of the invention;

FIG. 4 conceptually shows image center ICxy based on image radii IRx and IRy in accordance with the principles of the invention;

FIG. 5 is a high level flowchart conceptually illustrating steps of a methodology for creating a graphical user interface in accordance with the principles of the invention; and

FIG. 6 is a high level flowchart conceptually illustrating steps of a methodology for creating a graphical user interface including using dome camera system positioning in accordance with the principles of the invention.

### DETAILED DESCRIPTION

### Imaging System

An exemplary imaging system constructed in accordance with the principles of the invention includes components configured to transform digital image data corresponding to wide-angle images, such as video images, of a monitored area into data corresponding to one or more undistorted (or substantially undistorted) views of the monitored area that may be displayed on conventional closed circuit television (“CCTV”) monitors without use of a post-transformation output image buffer. Wide-angle image data may be transformed as needed for encoding and output.

Various image sources may supply image data for use by a system in accordance with the invention. By way of example and not limitation, one or more imagers such as digital or analog video cameras may be used to supply video data, which may be in any known format. Thus, unless otherwise apparent from the context, as used herein “video” broadly refers to images, such as images of stationary and/or moving objects, which may or may not be produced using signals in known formats, such as NTSC signals. The system of the invention may operate in real time, processing video data as it is produced using the video imagers and without appreciably delaying output to a display monitor or recorder. Alternatively, saved analog or digital video signals or data may serve as the source of images.

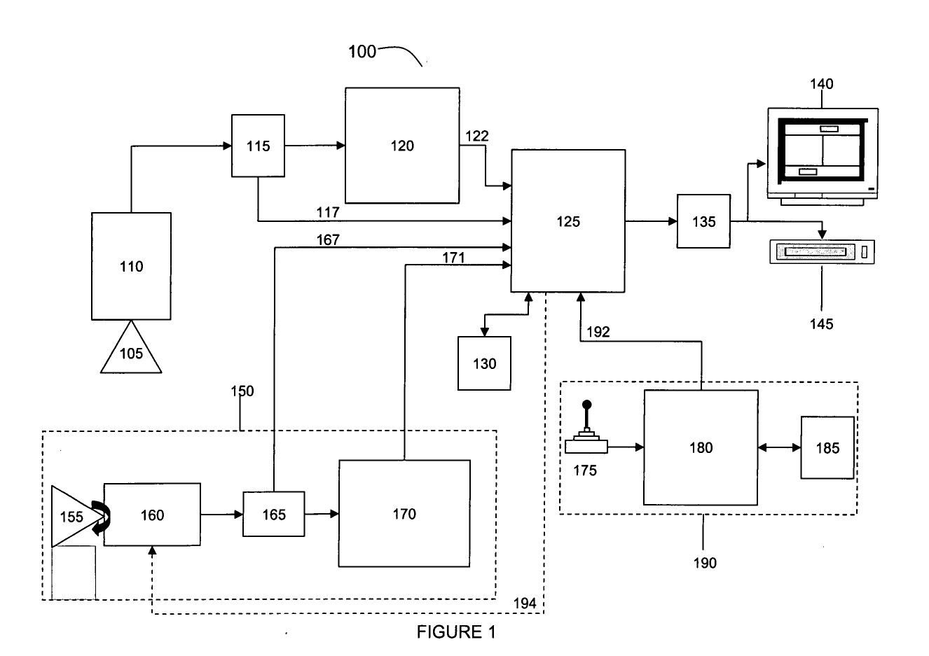

Referring now to FIG. 1, a high-level block diagram of a video imaging system 100 for use with a system in accordance with an exemplary implementation of the invention is shown. The video imaging system 100 includes a video camera 110 equipped with a wide-angle lens 105, such as a fisheye lens. Various wide-angle lenses are available, many of which, for example, have an angular field of view of approximately 75 degrees or more. The wide-angle lens may preferably be suitable for producing an image of an entire area to be monitored (e.g., portions of a room excluding the ceiling) when the wide-angle lens is positioned at a determined point relative to the monitored area (e.g., on a ceiling of the room, at or near the center of the ceiling, pointing downwardly). By way of example and not limitation, a fisheye lens, which is a type of wide-angle lens, and which may have a field of view of 180 degrees, may be utilized. The camera 110 may employ a charge coupled device (CCD) array, a Time Delay Integration (TDI) CCD array, complementary metal oxide semiconductor (CMOS) image sensors or other sensors or devices for electronic image production. Additionally, the camera 110 may be a digital or analog camera.

While wide-angle lenses are useful for capturing a wide field of view, they tend to distort images by curving or warping objects. Such curving or warping, also known as barrel distortion, is referred to herein as “distortion”, “wide-angle lens distortion” or the like. Typically, the wider the field of view for a lens, the more pronounced the distortion will be.

Unless otherwise apparent from the context, as used herein, “undistorted” means without any, or with substantially reduced, wide-angle image distortion. “Undistorted” data is produced by transforming wide-angle image data using mathematical algorithms, as discussed more fully below. An “undistorted image” is an image produced using “undistorted data.”

The wide-angle lens 105 is aimed at the area to be monitored. The lens 105 may be a fisheye lens or another type of wide-angle lens that provides a 180 degree field of view, or a wider or narrower field of view. By way of example, the lens may be a fisheye lens positioned on a ceiling near the center of a monitored room, aimed downwardly. This position and orientation may generate a view of substantially the entire monitored room, excluding the ceiling.

A video decoder 115 operably coupled to the camera translates analog signals from the camera into digital video data. The decoder 115 includes a clock circuit (e.g., a 27 MHz video clock circuit) suitable for synchronization and processing of video image data streams. Clock signals 117 from the clock circuit are transmitted to processor 125.

By way of example and not limitation, a suitable decoder 115 may include commercially available decoders, such as an SAA7113H 9-bit video input processor available from Phillips Electronics N.V. The SAA7113H 9-bit video input processor includes an anti-aliasing filter, an automatic clamp and gain control, a clock generation circuit, a digital multi-standard decoder, and a brightness, contrast and saturation control circuit. Decoder 115 may be able to decode Phase Alternation Line (PAL), French Sequential Couleur avec Memoire (SECAM) and American National Television Systems Committee (NTSC) standard signals into CCIR-601 (International Radio Consultative Committee, now the International Telecommunication Union Radiocommunication Sector, standard for encoding analog video signals in digital form) compatible color component data values. The SAA7113H 9-bit video input processor accepts as analog inputs CVBS (i.e., composite Chroma Video Blanking & Sync inputs) or S-video (Y/C).

Digital video data from decoder 115 may be stored in an input image buffer 120. The input image buffer 120 may be comprised of volatile or non-volatile memory or other devices configured to store video image data. The data may be stored temporarily, for example, until no longer needed for transformation by the image data processor 125, as described below, until new video image data is required to be stored in the occupied portion of the buffer, or until some other event occurs or a determined period of time elapses. The buffer 120 may be sized to store image data corresponding to an entire field or frame of video, or more or less data.

One or more user input modules 190 may also be provided to generate user commands. By way of example, the module may include an input device 175 such as a keypad, digitizer, joystick, microphone and voice recognition module, or some other device configured to enable a user to enter commands. The input device 175 may be operably coupled to an input processor 180 and input memory 185 configured to produce user command data 192 corresponding to user input commands. The input processor 180 may be implemented as a special purpose computer; a programmed general purpose computer; a programmed microprocessor, microcontroller or programmable read-only memory and peripheral integrated circuit elements; an application specific integrated circuit (ASIC) or other integrated circuits; a digital signal processor; a hardwired electronic or logic circuit such as a discrete element circuit; and/or a programmable logic device such as a field programmable gate array (FPGA), or the like. The input memory 185 may include volatile or non-volatile memory such as, for example, static random access memory (SRAM), dynamic random access memory (DRAM), fast page mode dynamic random access memory (FPM DRAM), extended data-out dynamic random access memory (EDO DRAM), synchronous dynamic random access memory (SDRAM), double data rate synchronous dynamic RAM (DDR SDRAM), electronically erasable programmable read only memory (EEPROM) such as flash memory with or without a controller, hard disk enabled virtual memory, and/or other data storage devices that may be operably coupled to the input processor 180. Using a user input device 175, a user may control pan, tilt, zoom factors, and other display parameters.

In an exemplary implementation, calculations that are required for transformation (as discussed more fully below), that are common to all or the vast majority of wide-angle image data to be transformed and vary only with wide-angle image parameters, pan, tilt, zoom or other user input commands, may be calculated using the input module 190. Delegating such computations to the input module may help conserve image data processor 125 resources and facilitate real-time transformations.

An image data processor 125 may receive buffered image data 122, clock signals 117 and user command data 192 to produce undistorted data. The processor 125 may be implemented as a special purpose computer; a programmed general purpose computer; a programmed microprocessor, microcontroller or programmable read-only memory and peripheral integrated circuit elements; an application specific integrated circuit (ASIC) or other integrated circuits; a digital signal processor; a hardwired electronic or logic circuit such as a discrete element circuit; and/or a programmable logic device such as a field programmable gate array (FPGA), or the like. A preferred implementation uses an FPGA or an ASIC as the processor 125. When a system design is considered stable, an FPGA could be replaced with an ASIC to reduce system cost.

The image data processor 125 may also be operably coupled to memory 130, which may, for example, be non-volatile memory comprised of electronically erasable programmable read only memory (EEPROM), such as flash memory; a solid-state floppy-disk card (SSFDC) such as SmartMedia® memory commercially available by Kabushiki Kaisha Toshiba, Toshiba Corporation, and Toshiba America Electronic Components, Inc.; CompactFlash® memory by SanDisk Corporation; hard disk enabled virtual memory; and/or other non-volatile storage devices. Illustratively, memory 130 may be used to used to facilitate processor computations by storing one or more tables of values for frequently calculated functions, especially functions that might otherwise consume significant processor 125 resources. By way of example and not limitation, memory 130 may store a table of values, such as cosine, sine, 1/cosine, 1/sine, or other values based on trigonometric or other types of functions used in an applicable transformation algorithm, as discussed more fully below. The indices for the table may be angular values in degrees, radians, other types of measurements, or some other possible value for a variable. The table entries may be pre-calculated values based on the corresponding indices. Trigonometric functions and complex floating point calculations can otherwise be a time and resource consuming part of processor 125 calculations. Advantageously, the use of pre-determined stored values conserves processor resources and may lead to an appreciable increase in overall transformation speed.

As discussed more fully below, the image data processor 125 mathematically transforms wide-angle image data in the input image buffer 120 into undistorted data using a transformation algorithm. In a preferred implementation, the image data processor 125 is configured to complete transformation calculations, on a pixel-by-pixel basis, as the data for a pixel is needed for encoding to produce output video signals in real-time. Transformation calculations are started far enough in advance such that the final calculation step is completed just in time to provide undistorted image data to the encoder. By way of example, one NTSC video frame, displayed approximately every 1/30^{th} of a second, contains two interlaced fields. Each field is displayed approximately every 1/60th of a second each. Thus, a system made in accordance with the principles of the invention may generate all undistorted pixel image data for a frame approximately every 1/30^{th} of a second. The time may be monitored using the 27 MHz clock circuit signals 217. To further illustrate, an interlaced NTSC display of 720 by 486 pixels and a refresh rate of 60 Hz, must display all the pixels for a field (i.e., 174,960 pixels) approximately every 1/60^{th} of a second, or a pixel must be generated approximately every 9.526×10⁻⁸ seconds.

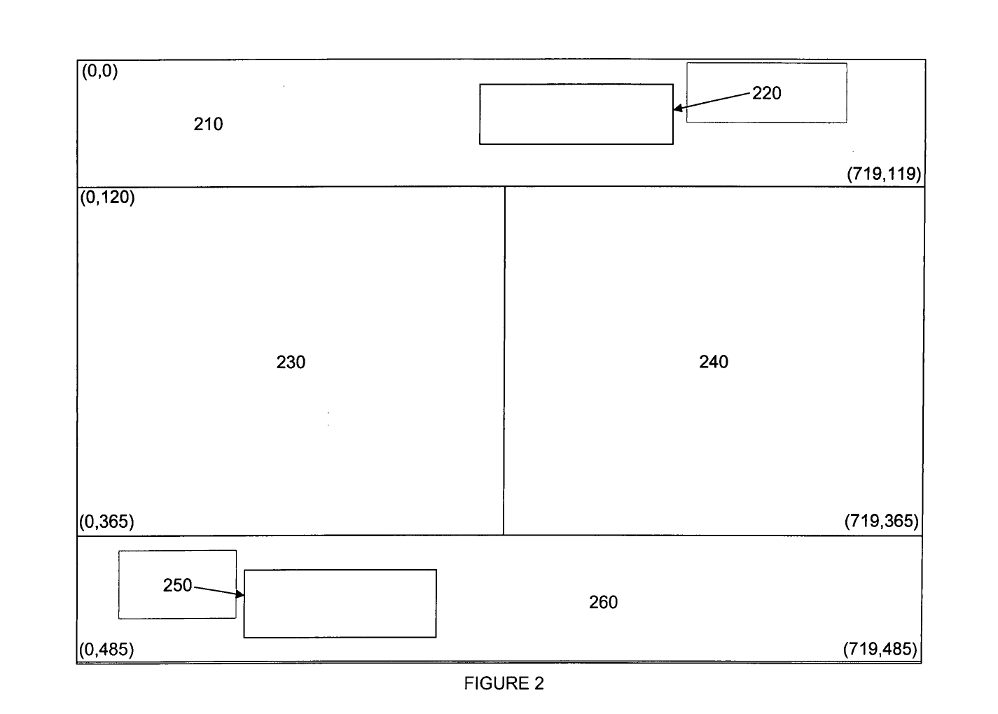

Upon transformation, the processor 125 sends transformed video data to an encoder 135. The encoder converts the digital video data into output signals compatible with an output device such as a standard CCTV display monitor 140 and/or video recorder 145. The monitor 140 may display a graphical user interface such as that described in the discussion of FIG. 2.

By way of example and not limitation, the encoder 135 may be any suitable commercially available decoder, such as an SAA7121H digital video encoder by Phillips Electronics, N.V. The SAA7121H digital video encoder circuit accepts CCIR compatible YUV data with 720 active pixels per line and encodes the digital YUV video data to NTSC, PAL, CVBS or S-video signals.

Output from the encoder 135 is sent to an output device, such as a standard CCTV display monitor 140 and/or video recorder 145. The display monitor may be any device configured to visually display images based on electronic video signals output from the encoder 135. The recorder may be any device configured to record video signals from the encoder 135 on removable or non-removable storage media such as, for example, a magnetic tape, diskette, CD-ROM, DVD, hard disk, memory (e.g., nonvolatile EEPROM) or the like. If both a display monitor 140 and recorder 145 are used, the devices may be configured in parallel or in series (e.g., without output from the video recorder being sent to a display monitor).

In an alternative embodiment, in addition to transforming wide-angle image data, the image data processor may produce output image data from one or more supplementary sources, such as an additional camera system 150. By way of example and not limitation, an additional camera system may include an analog or digital camera 160 with a normal lens 155 (i.e., not a wide-angle lens) aimed at a determined portion of the monitored area. The lens 155 may have a narrower Field of View (FOV), e.g., 45°, which would provide higher resolution than wide-angle lens 105, thus providing a more detailed video image. Such a configuration may enable displaying an undistorted image derived from transformed wide-angle lens image data as well as an image produced using the additional camera system. Such a configuration may also enable switching from a relatively low resolution undistorted image derived from wide-angle lens image data to a higher resolution image, with a higher zoom factor capability, produced using the additional camera system. This gives the user the ability to isolate small details of a monitored area.

The additional camera system 150 may also include a video decoder 165 that is operably coupled to the camera and configured to translate analog signals from the camera into digital video data. The decoder 165 may also include a clock circuit (e.g., a 27 MHz video clock circuit) suitable for synchronization and processing of video image data streams. Clock signals 167 may be transmitted to processor 125.

The additional camera system 150 may further include an image buffer 170. The image buffer 170 may be comprised of volatile or non-volatile memory or other devices configured to temporarily store video image data, such as, for example, static random access memory (SRAM), dynamic random access memory (DRAM), fast page mode dynamic random access memory (FPM DRAM), extended data-out dynamic random access memory (EDO DRAM), synchronous dynamic random access memory (SDRAM), double data rate synchronous dynamic RAM (DDR SDRAM), Rambus dynamic random access memory (RDRAM), multiport dynamic random access memory (MPDRAM), synchronous graphics RAM (SGRAM), electronically erasable programmable read only memory (EEPROM), hard disk enabled virtual memory and/or other data storage device. The buffer 170 may be sized to store image data corresponding to an entire field or frame of video, or more or less data. Buffered video data 172 may be transmitted to processor 125. That data may then be processed and encoded 135 for output to a display or recording device.

Moreover, the additional camera system 150 may be configured as a programmable dome camera system. Dome cameras can typically rotate (i.e., pan) 360 degrees, and tilt and zoom according to control signals. Processor 125 may produce control data 194, based upon user command data 192 from user input module 190, to control positioning and movement of the dome camera. A control interface (not shown) may also be operably coupled to dome camera 160 and processor 125, as necessary to convert control data output from the processor 125 into signals for controlling dome camera 160 position, movement and zooming.

### Transformation Methodology

Undistorted data may be produced by mathematically transforming wide-angle image data. Many transformation processes (also referred to as dewarping, mapping, remapping, planar projection, conversion and perspective correction) are known in the art and can be adapted, in accordance with the teachings herein, to produce undistorted data from wide-angle image data (including fisheye image data). While the invention is not limited to any specific transformation processes, an exemplary panoramic view transformation and an exemplary virtual view transformation are described more fully below for use with a system of the invention employing fisheye lens image data.

Referring now to FIG. 2, a graphical user interface in accordance with an exemplary implementation of the invention is conceptually shown. Strips 210 and 260, which may be rectangular in shape as illustrated, correspond to transformed panoramic views. The transformed panoramic views 210 and 260 exhibit upright orientation and substantially reduced (or no) wide-angle image distortion, thus providing a readily discernible view of the monitored area. An example of a suitable transformation carried out by the processor is discussed subsequently.

Also shown in FIG. 2 are one or more virtual views 230 and 240, each of which may be an undistorted view of a user-determined portion of the panoramic views 210 and 260. Virtual view data may be obtained either by transformation of portions of the wide-angle video image data, or by positioning and focusing a camera having a normal lens (i.e., not a wide-angle lens) to produce image data for the determined portion of the monitored area. Again, a suitable exemplary transformation to obtain the virtual view data is discussed subsequently.

The processor may be further configured to provide reference overlay (e.g., windows—i.e., graphically generated frames or boxes, or other shapes, overlaid in the panoramic views—frames 220 and 250 as shown in FIG. 2) corresponding to the undistorted view of the determined portions of the panoramic views represented by the virtual views 230 and 240. Thus, the reference overlay 220 and 250 reveals what portions of the panoramic views are represented by the virtual views 230 and 240.

As an operator pans, tilts or zooms either of the virtual views 230 and 240 to correspond to any part of either of panoramic views 210 and 260, the corresponding reference window 220 or 250 overlaid on top of a panoramic view 210 and 260 is adjusted by moving and/or changing its size in the panoramic view 210 or 260, to conform to the virtual view, thus indicating the part of the panoramic view 210 and 260 represented by the virtual view 230 or 240. Panning and tilting a virtual view 230 or 240 causes the reference window 220 or 250 to move horizontally and/or vertically in a panoramic view 210 or 260. Zooming in (i.e., increasing zoom) causes the reference window 220 or 250 to decrease in size in the panoramic view 210 or 260. Zooming out (i.e., decreasing zoom) causes the reference window 220 or 250 to increase in size in the panoramic view 210 or 260.

The system is preferably configured to allow a user to select which virtual view 230 or 240 to currently control. The active (i.e., currently controlled) virtual view 230 or 240 may be distinguished from the inactive virtual view by an indicia. For example, a white frame may surround the active virtual view and a black frame may surround the inactive virtual view. The corresponding reference window 220 or 250 may also be highlighted in either black or white based on its associated virtual view's active/inactive status.

The exemplary display screen may have a resolution of 720 by 486 pixels. The exemplary panoramic views, as shown in FIG. 2, are each 720 pixels wide and 120 pixels high. The exemplary virtual views, as shown in FIG. 2, may each be 360 pixels wide and 246 pixels high. Those skilled in the art will appreciate that the invention is not limited to the exemplary resolution or view sizes. Many other resolutions and sizes are feasible and come within the scope of the invention.

The reference overlay (e.g., reference windows 220 and 250) in an exemplary implementation conforms to virtual view 230 and 240 positioning and zooming. Thus, for example, a user may pan, tilt and zoom virtual view 230 and 240 to represent any portions of the panoramic views 210 and 260. The portions of the panoramic views represented by the virtual view 230 and 240 define the areas overlaid by reference windows 220 and 250. Other manifestations of reference overlay, such as numerical coordinates or cross hairs, may be used in lieu of or in addition to reference windows 220 and 250. In an alternative implementation, the system may be configured to automatically determine the portions of the panoramic views 210 and 260 to cover, such as by one or more determined algorithms (e.g., move reference windows as a function of time) or in response to one or more signals (e.g., a motion detector, gate sensor, or alarm signal).

Panoramic views 210 and 260 and virtual views 230 and 240 may be displayed concurrently on a display monitor, thus providing a readily discernible view of the entire monitored area and an undistorted view of a portion of the monitored area. The reference overlay 220 and 250 may also be displayed with the panoramic views 210 and 260, thus enabling a user to readily identify the portions of the panoramic views 210 and 260 that are represented by the virtual views 230 and 240.

Those skilled in the art will appreciate that the invention is not limited to the exemplary number, size, shape or arrangement of views shown in FIG. 2 and discussed above. For example, one or more panoramic views 210 and 260, and/or virtual views 230 and 240 and reference windows 220 and 250 may be provided within the scope of the invention. Thus, a display may show one (1) or more undistorted images produced from wide-angle image data, without departing from the scope of the invention. Additionally, the user interface components may be arranged as shown in FIG. 2 and discussed above, or differently, on one or more display monitors, or in one or more windowed portions of one or more display monitors, without departing from the scope of the invention. Furthermore, the interface may be configured to allow a user to control the display arrangement. For example, a user may hide or move a panoramic view 210 or 260, and/or a virtual view 230 or 240 and/or a reference window 220 or 250; or hide all virtual views 230 and 240 reference windows 220 and 250; or opt to display only a selected panoramic view 210 or 260 or virtual view 230 or 240.

The exemplary panoramic view transformation process involves mathematically transforming wide-angle video image data into 2-dimensional space for producing panoramic views. The exemplary transformation entails determining, for each output window pixel coordinate, an address within the image buffer 120 for pixel data to be encoded and output to a display 140 and/or recorder 145. In a preferred implementation, this address calculation is timed such that the calculated address for each output pixel is ready just in time to feed the output encoder. This implementation advantageously eliminates the need for an output image buffer.

In an exemplary implementation, two panoramic views 210 and 260 may be produced. One panoramic view 210 corresponds to half of the monitored area (e.g., a 0-180 degree panoramic view strip). The other panoramic view corresponds to the other half of the monitored area (e.g., a 181-360° panoramic view strip). Thus, in this implementation, the second panoramic view is offset from the first panoramic view by half of the field of view. The points dividing one half from the other half may be pre-programmed, user configurable or user controllable. The two panoramic views combined provide a full (e.g., a 360°) view of the monitored area.

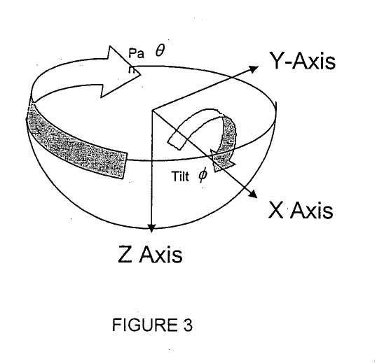

The exemplary panoramic views are 720 pixels wide and 120 pixels high. Output window pixel coordinates range from −360 to +360 for Wx and from −60 to +60 for Wy. The Wx and Wy coordinates are derived from the output view column and line pixel counters, and together with the desired Zoom factor, are transformed into 0 (i.e., the pan rotation angle around the Z-axis) and φ (the tilt rotation angle around the X-axis), as conceptually illustrated in FIG. 3. This information is then converted to an address in the input capture buffer. The data from this address is output to the encoder for display. The variables Pan, Tilt and Zoom may be programmed or commanded via user input module 190.

Given:

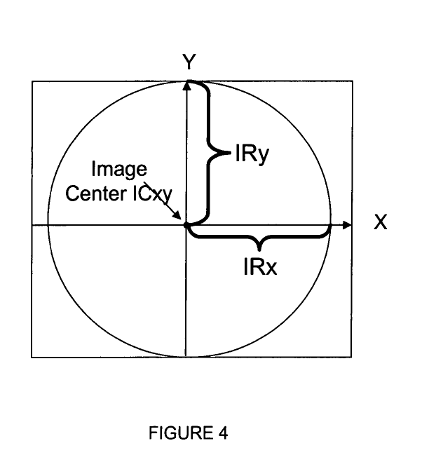

Zoom_{—}1X_Tilt_FOV=45°
ScaleFactorX (SFx)=180°/720 pixels=0.25°/pixel
Zoom Scale (ZS)=1 (Requested zoom factor, e.g., 1, 2, 3, etc.)
ScaleFactorY (SFy)=(Zoom_{—}1X_FOV)×(1/ZS/120 pixels)
ScaleFactorY (SFy)=45°/120 pixels=0.375°/pixel
Pan=Requested Pan angle in degrees
Tilt=Requested Tilt angle in degrees
Wx=Output Window pixel x coordinate (−360 to +360)
Wy=Output Window pixel y coordinate (+60 to −60
IRx=Image buffer fisheye image X axis radius in pixels
IRy=Image buffer fisheye image Y axis radius in pixels
ICx=Image buffer fisheye image center X coordinate in pixels, as conceptually shown in FIG. 4
ICy=Image buffer fisheye image center Y coordinate in pixels, as conceptually shown in FIG. 4.

The horizontal component of the panoramic view (starting with output window upper left at −360,+120) is converted from pixel units to degrees (SFx). Each output pixel equates to 0.25 degrees (180°/720 pixels). The programmable Pan value is added to each pixel value. The second panoramic view 260 is offset from the first 210 by +180 degrees.

Therefore:
φ=[(Wx+360)×SFx]+Pan=[(Wx+360)×0.25]+Pan Equation 1
θ=0.25Wx+90+Pan Equation 2

The vertical component of the panoramic view (starting with output window upper left at origin −360,+120) is converted from pixel units to degrees (SFy). Each vertical pixel equates to 0.375 degrees (45°/120 lines). The programmable Tilt value is added to each pixel value. The programmable zoom performs a scale (45°×(1/zoom))/120. Therefore, Zoom Scale equals 1.
φ=(π/2−Tilt)−[(Wy+60)×(SFy)] Equation 3
φ=90−Tilt−0.375Wy−22.5 Equation 4
φ=67.5−(Tilt+0.375Wy) Equation 5
Radius=−φ/π/2 Equation 6
Radius=−/90 Equation 7

Next, the input image X,Y (Ixy) pixel is calculated, as follows:
Ix=(Radius×cos(θ)×IRx)+ICx Equation 8
Iy=(Radius×sin(θ)×IRy)+ICy Equation 9

The image buffer 120 is preferably addressed as a 1024 byte by 1024 byte array. The memory location, in the image buffer for the pixel data is calculated by:
PixelData=(Iy×1024)+Ix Equation 10

PixelData may then be sent to the encoder 135 for output to the output device such as a display monitor 140 and or a recorder 145. Pixel Data for each pixel comprising the panoramic views 210 and 260 may be determined in a similar manner.

Each virtual view window 230 and 240 provides a perspective corrected view (e.g., a view with no, or substantially reduced, fisheye distortion) of any portion of a panoramic view 210 or 260. The virtual view windows are preferably 360 pixels wide and 240 pixels high. The center of the window is defined as 0,0. Wx values range from −180 to +180 and Wy values range from +120 down to −120. The Wx and Wy coordinates are taken from the output window line and pixel counters and, together with the desired Pan, Tilt and Zoom Scale, are transformed into θ, φ, and Radius using the virtual view transformation algorithm. The processor determines which algorithm (i.e., the virtual view transformation algorithm or the panoramic view transformation algorithm) to use based on where the counters indicate it is in the output video frame. As with the panoramic views, θ is defined as the Pan angle around the Z-Axis, where the positive Y direction, as shown in FIG. 3, is 0 degrees. Additionally, φ is the Tilt angle around the X-Axis where the positive Z direction, pointing straight down as shown in FIG. 3, is 0 degrees. Z is the perpendicular distance from the X-Y plane down to the surface of a unity radius hemispheric fisheye model.

The virtual view transformation algorithm entails converting the X and Y output window coordinates to an equivalent proportion of a unity radius hemisphere model using a current Zoom factor and a measured radius-X and radius-Y from an input fisheye circular image. These adjusted values are used to calculate a corresponding Z value. The X, Y and Z coordinates are rotated around the unity radius hemisphere model using the commanded Pan and Tilt from the user input module 190. The rotated X and Y values are then rescaled back to pixels and lines, based on measured radius-X and radius-Y from the input fisheye circular image. The rescaled X and Y are then converted to an address in the input image buffer 120. Data from this address is then output to the encoder 135 for display. The variables Pan, Tilt, and Zoom are the angle of interest commanded by the user input module 190.

Given:

Pan=Commanded Pan angle in degrees
Tilt=Commanded Tilt angle in degrees
Zoom=Requested Zoom scale (e.g., 1, 2, 3, etc.)
Wx=Output Window pixel x coordinate (−180 to +180)
Wy=Output Window pixel y coordinate (+120 to −120)
IRx=Image buffer fisheye image X axis radius in pixels
IRy=Image buffer fisheye image Y axis radius in pixels
ICx=Image buffer fisheye image center X coordinate in pixels, as conceptually shown in FIG. 4
ICy=Image buffer fisheye image center Y coordinate in pixels, as conceptually shown in FIG. 4

The vertical and horizontal components of the virtual view window (center at origin 0,0) are converted from pixel units to unit values from 0 to less than one by dividing the pixel number by the respective image radius. One is the maximum length from the center of the virtual output image, to the edge of the image. By scaling to the image radius much of the three-dimensional transformation math can be simplified.
Wx=WindowX/IRx Equation 11
Wy=WindowY/IRy Equation 12

To scale the Wx and Wy components by Zoom, the following equations are used.
Wx=Wx×1/Zoom Equation 13
Wy=Wy×1/Zoom Equation 14

The desired radius squared is calculated from the vertical and horizontal components using the Pythagorean theorem.
Wr²=Wx²+Wy² Equation 15

For each pixel, to convert the two dimensional radius squared and scaled components to a three dimensional value with a unit radius of 1, the following equations are used.

Given:
Ix²+Iy²+Iz²=1 Equation 16
Then:
Iz=\sqrt{1−Wr²} Equation 17

Assuming the acquired image center is perpendicular to the Z axis, a rotation of the desired window to a desired spot on the image can be performed using the Pan and Tilt values to simulate a movable dome.

To rotate around the X axis for tilt, the following equations are used.
Iz′=(Iz×cos(Tilt))−(Wy×sin(Tilt)) Equation 18
Wy′=(Wy×cos(Tilt))+(Iz×sin(Tilt)) Equation 19

To rotate around the Z axis for pan, the following equations are used.
Wx′=(Wx×cos(Pan))−(Wy′×sin(Pan)) Equation 20
Wy′=(Wx×sin(Pan))+(Wy′×cos(Pan)) Equation 21

To convert unit values to Image Buffer pixel units, the following equations are used.
Ix×=Wx′×IRx Equation 22
Iy=Wy′×IRy Equation 23

To align the origin relative to upper left of input image buffer, the following equations are used.
Ix=Ix+ICx Equation 24
Iy=Iy+ICy Equation 25

The image buffer 120 may be addressed as a 1024 byte by 1024 byte array. The memory location, in the image buffer 120, for the pixel data is calculated using the following equation.
PixelData=(Iy×1024)+Ix Equation 26

PixelData may then be sent to the encoder 135 for output to the display window.

Advantageously, the panoramic views 210 and 260 provide context for the virtual views 230 and 240. A user never loses sight as to what is happening in the monitored area outside a virtual view, even as the user zooms in on a specific event or object. The user does not have to keep changing video sources to view areas outside the virtual views 230 and 240. Concomitantly, the reference windows 220 and 250 provide a visual indication of the portion of a panoramic view represented by a virtual view. Thus a user can readily determine where in a monitored area they are looking. In an embodiment that includes an additional dome camera system, the ability to switch to the additional camera to produce a high resolution, high zoom factor, virtual view gives the user the ability to resolve small details of a scene.

Other transformation algorithms may be used for transforming wide-angle image data according to the principles of the invention. In selecting or deriving suitable algorithms, various factors may come into play, including, for example, available system resources (e.g., processor type and speed, and memory), cost, speed and output quality. Thus, an algorithm may be better suited for one system configuration over another system configuration. Additionally, a system intended for a particular purpose, e.g., a high resolution progressive display, may benefit more from or demand a fast algorithm to generate the required undistorted pixel data in a timely manner.

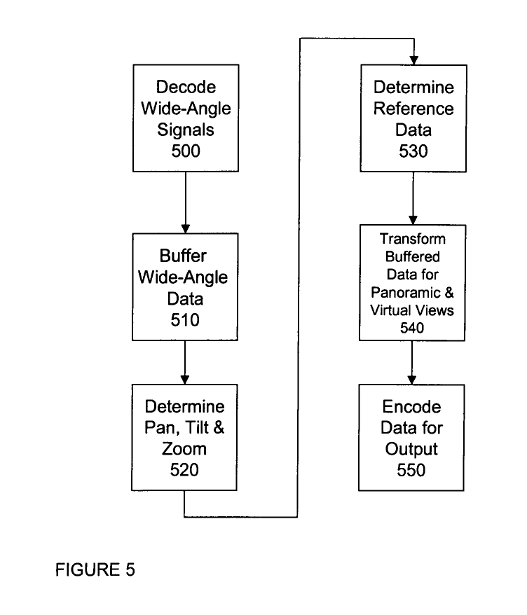

Referring now to FIG. 5, a high level flow chart illustrating a process for producing an undistorted image in accordance with an exemplary implementation of the invention is shown. The steps may be implemented using a system with a programmed processor as described above. FIG. 5 may equally represent a high level block diagram of an exemplary system constructed in accordance with the invention, implementing the steps thereof.

In step 500, wide angle image signals are decoded into digital wide-angle image data. The signals may be supplied from a video camera system or from a source of pre-recorded data.

In step 510, the decoded wide-angle data (e.g., fisheye lens image data) is buffered. Buffering entails storing the data in an input image buffer.

Next, in step 520, pan, tilt and zoom data are obtained to specify regions of interest from the buffered wide-angle data for display. Pan, tilt and zoom data may be supplied via a user input module, such as user input module 290. Those skilled in the art will appreciate that values other than pan, tilt and zoom (e.g., Cartesian coordinate values) may be specified to define areas of interest in the panoramic views.

Next, in step 530, buffered wide-angle data are transformed using a transformation algorithm. The wide-angle image data is preferably transformed, on a pixel-by-pixel basis, as the data for a pixel is required for encoding, to produce output signals in real-time. The transformation may, for example, be carried out according to a transformation process as described above.

Next, in step 540, as data is transformed in step 530, the transformed data is encoded for output. The encoded output may then be sent to a display monitor and/or to a recorder.

Those skilled in the art will appreciate that the order in which some of the steps are performed may vary from the order shown in the flowchart without departing from the scope of the invention. For example, a pre-programmed pan, tilt and zoom may be determined before wide-angle data is initially buffered.

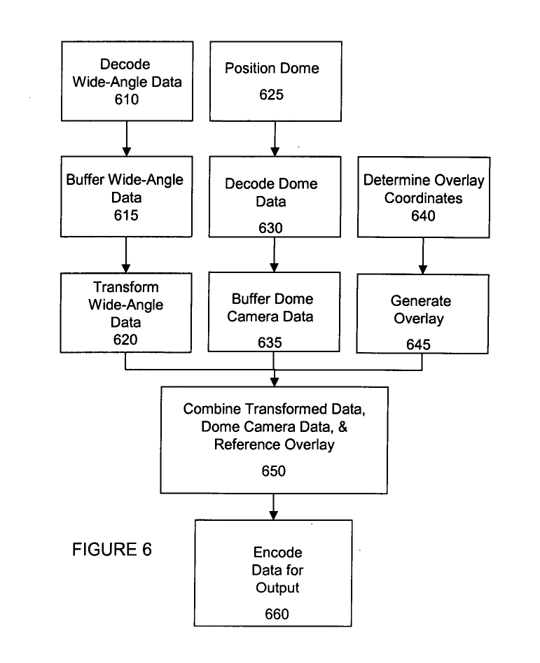

Referring now to FIG. 6, a high level flow chart illustrating another process for producing an undistorted image in accordance with an exemplary implementation of the invention is shown. As with the process illustrated by the flowchart of FIG. 5, the steps may be implemented using a system with a programmed processor as described above. FIG. 6 may equally represent a high level block diagram of an exemplary system constructed in accordance with the invention, implementing the steps thereof.

In step 610, wide-angle image signals are decoded into digital wide-angle image data. The signals may be supplied from a video camera system or from a source of pre-recorded data. Next in step 615, the decoded wide-angle image data (e.g., fisheye lens image data) is buffered.

Next, in step 620, buffered wide-angle data are transformed, for example, using a panoramic transformation algorithm for panoramic view data, and using a virtual view transformation algorithm for virtual view data. The wide-angle image data are preferably transformed, on a pixel-by-pixel basis, as the data for a pixel is required for encoding, to produce output signals in real-time. The transformation may, for example, be carried out according to a transformation process as described above.

In step 625 the dome camera is positioned. Dome camera positioning signals may be obtained from user input, such as user input of pan, tilt and zoom data or commands. The communicated positioning signals will cause the dome camera to aim at and zoom to the region of the monitored area corresponding to the determined pan, tilt and zoom values. Those skilled in the art will appreciate that values other than pan, tilt and zoom (e.g., Cartesian coordinate values) may be specified to define areas of interest in the panoramic views.

Next, in step 630, dome camera signals are decoded into digital dome camera image data. The signals are supplied from a dome camera system. Then, in step 635, the decoded dome camera image data is buffered. The buffered dome camera data may be encoded, without transformation, for output to a display monitor and/or to a recorder.

In step 640, coordinates are determined for overlaying a reference window in a panoramic view. The overlaid reference window, which is generated in step 645, reveals the portion of a panoramic view represented by a virtual view.

In step 650, buffered dome camera data, buffered wide-angle data, and data corresponding to a reference window are combined. The combined transformed wide-angle data, dome camera data and pixel data corresponding to the reference window are encoded, as in step 660. The dome camera data may defines a virtual view. The transformed data may define another virtual view and panoramic views. The pixel data corresponding to the reference window defines a reference window. The encoded output may be sent to a display monitor and/or to a recorder.

Those skilled in the art will appreciate that the order in which some of the steps are performed may not be important. For example, the reference overlay coordinates may be determined before, after or during transformation of the buffered data. Additionally, by way of example, a pre-programmed pan, tilt and zoom may be determined before the wide-angle data is initially buffered. As another example, dome position data may be sent before reference overlay is determined. As yet another example, dome data may be buffered after transformation of wide-angle data. Also, dome camera data may be obtained by the processor before completion of transformation. Additionally, various steps may be performed concurrently. Such variations in order are intended to come within the scope of the invention.

Although the foregoing description is directed to preferred embodiments of the invention, it is noted that other variations and modifications will be apparent to those skilled in the art, and may be made without departing from the spirit or scope of the invention.

1. A system for correcting wide-angle image data, said system comprising:
a first input buffer configured to store wide-angle image data;
an image data processor operably coupled to said first input buffer and configured to transform wide angle image data stored in the first input buffer into corrected image data;
an encoder operably coupled to said image data processor and configured to receive and encode the corrected image data in a format suitable for at least one of display and recording of corrected images; and
wherein said corrected image data is not stored in a buffer from the time of transformation by the image data processor until the time said undistorted image data is received by the encoder.

2. A system according to claim 1, wherein:
said encoder is further configured to output signals for producing corrected images comprising a plurality of pixels; and
said image data processor is configured to transform wide angle image data stored in said first input buffer into corrected image data by determining, for each of said plurality of pixels, wide angle image data that corresponds to each of said plurality of pixels, and providing said wide angle image data to said encoder.

3. A system according to claim 1, further comprising:
a look-up table memory operably coupled to the image data processor, said look-up table memory being configured to store transformation calculation data to be used by the image data processor to transform wide angle image data stored in the first input buffer into corrected image data.

4. A system according to claim 1, further comprising:
a user input module operably coupled to the image data processor and configured to provide user command data to the image data processor.

5. A system according to claim 4, wherein:
said user input module is further configured to calculate a value based on user input, and to communicate said calculated value to the image data processor; and
said image data processor is further configured to use said calculated value to transform wide angle image data stored in the first input buffer into corrected image data.

6. A system according to claim 1 wherein said image data processor comprises a processing device selected from the group consisting essentially of a field programmable gate array and an application specific integrated circuit.

7. A system according to claim 1, further comprising a source of wide-angle image data operably coupled to said first input buffer.

8. A system according to claim 1, further comprising a second input buffer configured to store image data different form the wide-angle image data stored in said first input buffer, said second input buffer being operably connected to said image data processor.

9. A system according to claim 8, said system further comprising a first source of wide-angle image data operably coupled to said first input buffer, and a second source of normal field of view image data operably coupled to said second input buffer.

10. A system according to claim 7, wherein said source of wide-angle image data comprises a video camera.

11. A system according to claim 10 wherein the video camera produces video signals in a standard format selected from the group consisting essentially of PAL, SECAM and NTSC.

12. A system according to claim 1, further comprising a monitor operably coupled to said encoder for displaying corrected images.

13. A system according to claim 1, wherein the wide-angle image data includes distortion and said image data processor transforms the wide-angle image data in the first input buffer into corrected image data that is substantially undistorted.

14. A method for displaying and/or recording corrected image data from wide-angle image data, said method comprising steps of:
buffering wide-angle image data;
transforming the buffered wide-angle image data into corrected image data; and
encoding the corrected image data into one or more output signals, without buffering the corrected image data; and
displaying and/or recording the output signals from the encoder.

15. A method according to claim 14, wherein the output signals correspond to a corrected image comprising a plurality of pixels and said step of transforming further includes determining, for each of said plurality of pixels, wide angle image data that corresponds to each of said plurality of pixels, and providing the wide angle image data for encoding.

16. A method according to claim 14, further comprising steps of:
storing transformation calculation data in a look-up table; and
using transformation calculation data stored in the look-up table to transform the buffered wide angle image data stored into corrected image data.

17. A method according to claim 14, further comprising steps of:
providing user command data to the image data processor; and
using the user command data to transform the buffered wide angle image into corrected image data.

18. A method according to claim 17, further comprising steps of:
calculate a value based on user command data; and
using said calculated value to transform the buffered wide angle image data into corrected image data.

19. A method according to claim 14 wherein the step of transforming the buffered wide-angle image data into corrected image data corrects distortion in the wide-angle image data such that the output signals are representative of a substantially undistorted image.

20. A method according to claim 14, further comprising the step of buffering normal field of view input image data and making said normal field of view input image data accessible to the image data processor.

21. A system for correcting wide-angle image data, said system comprising:
means for storing wide-angle image data;
means for transforming wide angle image data stored in said storage means into corrected image data, said image transformation means being operably coupled to said storage means; and
means for encoding the corrected image data into a format suitable for at least one of display and recording of corrected images without storing the corrected image data in a buffer from the time of transformation by the image transformation means until the time the corrected image data is received by the encoder means, said encoder means being operably coupled to said image transformation means.
